(19) United States
(12) Patent Application Publication
(10) Pub. No.: US 2008/0080682 A1
(43) Pub. Date: Apr. 3, 2008

(54) SYSTEM AND METHOD FOR DISPLAYING PRICES VIA AN ELECTRONIC DEVICE

(75) Inventors: Olawale K. Ogunwale, Overland Park, KS (US); Timothy C. Rozum, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 11/548,964

(22) Filed: Oct. 12, 2006

Related U.S. Application Data
(60) Provisional application No. 60/827,618, filed on Sep. 29, 2006.

(51) Int. Cl. H04M 11/00

(52) U.S. Cl. 379/93.17

(57) ABSTRACT

A device, system, and method which permit consumers to more effectively and efficiently shop for the lowest priced goods and services such as fuel. The device includes a GPS receiver for receiving satellite signals from GPS satellites and for determining a current location of the electronic device as a function of the satellite signals; a display; and a computing device coupled with the GPS receiver and the display. The computing device displays prices for sellers within a geographic area selected by the user or related to the current location of the device. The computing device determines an average price charged by certain sellers within the geographic area and indicates which sellers have prices above or below the calculated average price. The device also displays distances between the user's current location and the sellers and provide routing or other directions to a selected seller.

### RELATED APPLICATIONS

The present non-provisional application claims the priority benefit of U.S. Provisional Application No. 60/827,618, entitled SYSTEM AND METHOD FOR DISPLAYING FUEL PRICES CHARGED BY FUEL STATIONS VIA A PERSONAL USE ELECTRONIC DEVICE, filed Sep. 29, 2006. This provisional application is incorporated herein by specific reference.

### BACKGROUND OF THE INVENTION

1. Field of the Invention

The present invention relates to electronic devices such as navigation devices and the like. More particularly, the invention relates to a system and method for displaying and comparing prices charged by sellers in a geographic area using an electronic device.

2. Description of the Related Art

Consumers often comparison shop for the lowest priced goods or services. For example, consumers often comparison shop for the lowest priced fuel when fueling their motor vehicles. With widespread use of personal use electronic devices such as navigation devices, personal travel assistants, GPS-enabled mobile telephones, and GPS-enabled personal digital assistants (PDAs), consumers may be navigated to the closest fuel stations or sellers of other goods or services within a given geographic area. However, where several nearby sellers are available, no way exists of comparing the prices charged by the sellers other than driving to each seller to ascertain the price charged for a product or service, then manually comparing prices. Consumers therefore typically identify the sellers with the perceived lowest prices based on previous knowledge and then buy their goods or services at these sellers exclusively until they learn of lower prices at different sellers. Unfortunately, this method is not always effective because sellers, and especially fuel stations, frequently change their prices, and sellers which have the lowest prices one day may have relatively higher prices the next.

### SUMMARY OF THE INVENTION

The present invention solves the above-described problems and provides a distinct advance in the art of price comparison shopping. More particularly, the invention provides a device, system, and method which permit consumers to more effectively and efficiently comparison shop for goods or services.

The present invention may be implemented with a personal use electronic device such as a portable navigation device, personal travel assistant, GPS-enabled mobile telephone, or GPS-enabled personal digital assistant (PDA). One embodiment of the electronic device includes a GPS receiver for receiving satellite signals from a plurality of GPS satellites and for determining a current location of the electronic device as a function of the satellite signals; a display; and a computing device coupled with the GPS receiver and the display.

The computing device is configured to display prices for sellers of a product or service within a geographic area selected by the user or related to the current location of the electronic device. The computing device compares the prices charged by sellers within the geographic area and indicates which sellers have prices above or below other sellers. The device may also display distances between the user's current location and the sellers and provide routing or other directions to a selected seller. For example, the device may determine and display at least one fuel price for fuel stations within five miles of the device's current location, determine a mean or median price for a fuel sold by the fuel stations, and indicate which of the fuel stations have a fuel price which is above or below the mean or median price. A user may then select one of the fuel stations and be provided with a route or other navigation assistance to the selected station.

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1 is an isometric view illustrating an electronic device in accordance with an exemplary embodiment of the present invention;

FIG. 2 is a block diagram illustrating certain components of the device of FIG. 1;

FIG. 3 is schematic diagram of a Global Positioning System (GPS) that may be utilized by various embodiments of the present invention;

FIG. 4 is a flow diagram illustrating selected steps in a method for displaying fuel prices charged by fuel stations in a geographic area;

FIG. 5 is a sample screen display of the electronic device of FIGS. 1 and 2, illustrating display of fuel price information by the electronic device; and

FIG. 6 is another sample screen display of the electronic device of FIGS. 1 and 2, illustrating display of fuel price information by the electronic device.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense.

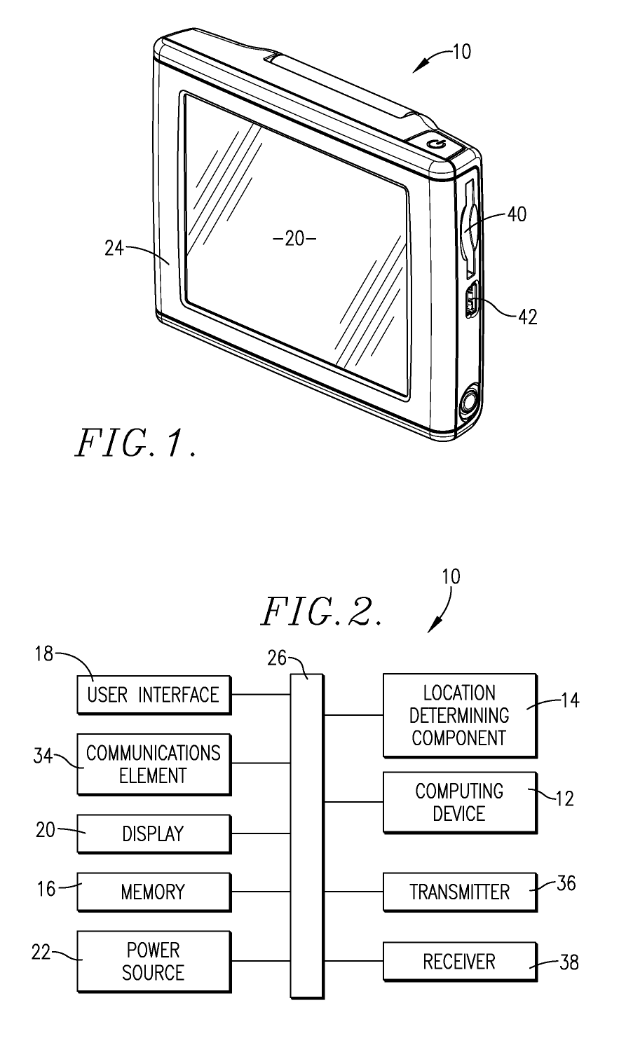

The present invention can be implemented in hardware, software, firmware, or a combination thereof. In one embodiment, however, the invention is implemented with a portable electronic device 10, an example of which is illustrated in FIG. 1. The electronic device 10 may be any device operable to receive, utilize, or otherwise determine geographic information such as a current location of the device. Thus, the device 10 may include computers, televisions, radios, portable computing devices such as laptops or personal data assistants (PDAs), cellular telephones, and portable entertainment devices. More preferably, the electronic device 10 is a portable navigation device such as a GPS navigation device, a GPS-enabled cell phone, or a GPS-enabled PDA. Examples of such navigation devices and personal travel assistant devices are manufactured by GARMIN INTERNATIONAL, INC. of Olathe, Kans. The electronic device 10 and its components illustrated and described herein are merely examples of a device and components that may be used to implement the present invention and may be replaced with other devices and components without departing from the scope of the present invention.

As described herein, embodiments of the electronic device 10 are configured to display fuel price information and related navigation information and data. However, embodiments of the device may also be configured to display price information for other goods, services, and items at other sellers including grocery stores, restaurants, clothing stores, liquor stores, discount stores, etc. For example, the device 10 may display pricing information for oil changes or other vehicle services at vehicle service centers, pricing information for meals and other food at restaurants, and pricing information for groceries at grocery stores.

As best illustrated in FIGS. 1 and 2, an embodiment of the electronic device 10 includes a computing device 12, a location determining component 14, a memory 16, a user interface 18, a display 20, a power source 22, and a housing 24 for housing the various components of the device 10.

In more detail, the computing device 12 may include any number of processors, controllers, integrated circuits, programmable logic devices, or other computing devices and resident or external memory for storing data and other information accessed and/or generated by the device 10. The computing device 12 is preferably coupled with the location determining component 14, memory 16, user interface 18, and display 20, through wired or wireless connections, such as a data bus 26, to enable information to be exchanged between the various components.

In accordance with one important aspect of the invention, the computing device 12 implements a computer program which controls the display of price-related information and other information on the display 20 as described herein. The computer program preferably comprises an ordered listing of executable instructions for implementing logical functions in the computing device. The computer program can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The location determining component 14 may be a parallel channel global positioning (GPS) receiver, and provides, in a substantially conventional manner, geographic location information for the device 10. The location determining component may be, for example, a GPS receiver much like those provided in products by Garmin Corporation and disclosed in U.S. Pat. No. 6,434,485, which is incorporated herein by specific reference.

In general, the GPS is a satellite-based radio navigation system capable of determining continuous position, velocity, time, and direction information for an unlimited number of users. Formally known as NAVSTAR, the GPS incorporates a plurality of satellites which orbit the earth in extremely precise orbits. Based on these precise orbits, GPS satellites can relay their location to any number or receiving units.

The GPS system is implemented when a device specially equipped to receive GPS data begins scanning radio frequencies for GPS satellite signals. Upon receiving a radio signal from a GPS satellite, the device can determine the precise location of that satellite via one of different conventional methods. The device will continue scanning for signals until it has acquired at least three different satellite signals. Implementing geometrical triangulation, the receiver utilizes the three known positions to determine its own two-dimensional position relative to the satellites. Acquiring a fourth satellite signal will allow the receiving device to calculate its three-dimensional position by the same geometrical calculation. The positioning and velocity data can be updated in real time on a continuous basis by an unlimited number of users.

Although GPS enabled devices are often used to describe navigational devices, it will be appreciated that satellites need not be used to determine a geographic position of a receiving unit since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. In this way, personal hand held devices, cell phones, intelligent appliances, intelligent apparel, and others can be readily located geographically, if appropriated equipped to be a receiving unit.

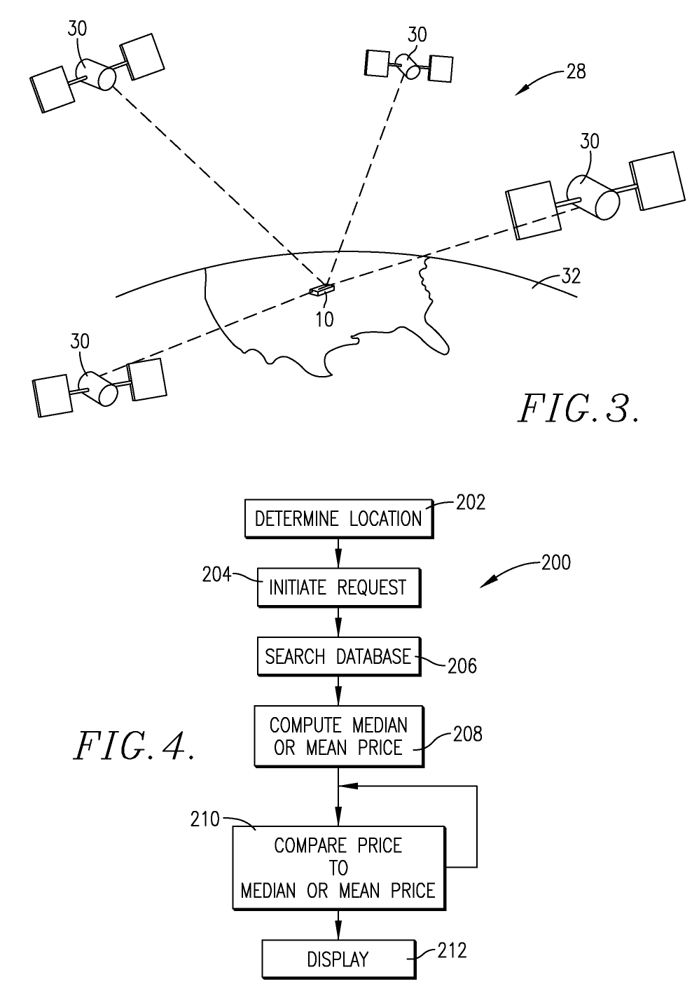

FIG. 3 shows one representative view of a GPS denoted generally by reference numeral 28. A plurality of satellites 30 are in orbit about the Earth 32. The orbit of each satellite is not necessarily synchronous with the orbits of other satellites and, in fact, is likely asynchronous. A GPS receiver device 10 such as the ones described in connection with preferred embodiments of the present invention is shown receiving spread spectrum GPS satellite signals from the various satellites 30.

The spread spectrum signals continuously transmitted from each satellite 30 utilize a highly accurate frequency standard accomplished with an extremely accurate atomic clock. Each satellite 30, as part of its data signal transmission, transmits a data stream indicative of that particular satellite. The device 10 must acquire spread spectrum GPS satellite signals from at least three satellites for the GPS receiver device to calculate its two-dimensional position by triangulation. Acquisition of an additional signal, resulting in signals from a total of four satellites, permits the device 10 to calculate its three-dimensional position.

The location determining component 14 and computing device 12 are operable to receive navigational signals from the GPS satellites 30 and to calculate a position of the device 10 as a function of the signals. The location determining component 14 and/or the computing device 12 are also operable to calculate a route to a desired location, provide instructions to navigate to the desired location, display maps and other information on the display screen 20, and to execute other functions described herein.

The location determining component 14 may include one or more processors, controllers, or other computing devices and memory so that it may calculate location and other geographic information without the computing device 12 or it may utilize the components of the computing device 12. Further, the location determining component 14 may be integral with the computing device 12 such that the location determining component 14 may be operable to specifically perform the various functions described herein. Thus, the computing device 12 and location determining component 14 can be combined or be separate or otherwise discrete elements.

In other embodiments, the location determining component 14 need not directly determine the current geographic location of the device 10. For instance, the location determining component 14 may determine the current geographic location by receiving location information directly from the user, through a communications network, or from another electronic device.

The location determining component 14 includes an antenna to assist the location determining component in receiving signals. The antenna may be a removable quad-helix antenna or any other type of antenna that can be used with navigational devices. The antenna may be mounted directly on or in the housing 24 or may be mounted external to the housing.

The memory 16 may store cartographic data and routing information used by or generated by the location determining component 14 or the computing device 12. The memory may be integral with the location determining component 14, integral with the computing device 12, stand-alone memory, or a combination of both. The memory may include, for example, removable and non-removable memory elements such as RAM, ROM, flash, magnetic, optical, USB memory devices, and/or other conventional memory elements.

The memory 16 may store various data associated with operation of the device 10, such as the computer program and code segments mentioned above, or other data for instructing the computing device 12 and other device 10 elements to perform the steps described below. Further, the memory 16 may store various cartographic data corresponding to geographic locations including map data, and map elements, such as thoroughfares, terrain, alert locations, points of interest, geographic entities, radio stations, and other navigation data to facilitate the various navigation functions provided by the device 10. Additionally, the memory 16 may store destination addresses and previously calculated or otherwise acquired routes to various destination addresses for later retrieval by the processor 12. Finally, the memory 16 may store a database of seller and price related information as described below.

The various data stored within the memory 16 may be associated within one or more databases to facilitate retrieval of the information. For example, the databases may be configured to enable the computing device 12 to automatically retrieve geographic locations, geographic entities, and seller information based upon a current geographic location of the device 10 as discussed in more detail below.

The user interface 18 permits a user to enter search queries and other information into the device 10 and enables users, third parties, or other devices to share information with the device 10. The user interface 18 is generally associated with the housing 24, such as by physical connection through wires, etc, or wirelessly utilizing conventional wireless protocols. Thus, the user interface 18 need not be physically coupled with the housing 24.

The user interface 18 may comprise one or more functionable inputs such as buttons, switches, scroll wheels, a touch screen associated with the display 20, voice recognition elements such as a microphone, pointing devices such as mice, touchpads, trackballs, styluses, a camera such as a digital or film still or video camera, combinations thereof, etc. Further, the user interface 18 may comprise wired or wireless data transfer elements such as removable memory including the memory 16, data transceivers, etc, to enable the user and other devices or parties to remotely interface with the device 10. The device 10 may also include a speaker for providing audible instructions and feedback.

The user interface 18 may be operable to provide various information to the user utilizing the display 20 or other visual or audio elements such as a speaker. Thus, the user interface 18 enables the user and device 10 to exchange information relating to the device 10, including fuel station information, geographic entities, configuration, security information, preferences, route information, points of interests, alerts and alert notification, navigation information, waypoints, a destination address, etc.

The display 20 is coupled with the computing device 12 and is operable to display various information corresponding to the device 10, such as price information, maps, locations, and directions as is described below. The display 20 may comprise conventional black and white, monochrome, or color display elements including CRT, TFT, LCD, and/or plasma display devices. Preferably, the display 20 is of sufficient size to enable the user to easily view the display 20 to receive presented information while in transit.

Further, as described above, the display 20 may be integrated with the user interface 18, such as in embodiments where the display 20 is a touch-screen display to enable the user to interact with the display 20 by touching or pointing at display areas to provide information to the device 10.

The power source 22 is associated with the housing 24 to provide electrical power to various device 10 elements. For example, the power source 22 is preferably directly or indirectly coupled with the user interface 18, location determining component 14, processor 12, memory 16, and/or display 20. The power source 22 may comprise conventional power supply elements, such as batteries, battery packs, etc. The power source 22 may also comprise power conduits, connectors, and receptacles operable to receive batteries, battery connectors, or power cables. For example, the power source 22 may include both a battery to enable portable operation and a power input for receiving power from an external source such an automobile.

In some embodiments, the device 10 may include a communications element 34 to enable the device 10 to communicate with other electronic devices or any other network enabled devices through a communication network, such as the Internet, a local area network, a wide area network, an ad hoc or peer to peer network, or a direct connection such as a USB, Firewire, or Bluetooth™ connection, etc. Similarly, the device 10 may be configured to allow direct communication between similarly configured navigation devices, such that the device 10 need not necessarily utilize the communications network to share geographic location information.

In various embodiments the communications element 34 may enable the device 10 to wirelessly communicate with the communications network utilizing wireless data transfer methods such as WiFi (802.11), Wi-Max, Bluetooth™, ultra-wideband, infrared, cellular telephony, radio frequency, etc. However, the communications element 34 may couple with the communications network utilizing wired connections, such as an Ethernet cable, and is not limited to wireless methods.

The device 10 may further include a transmitter 36 and receiver 38 or transceiver assembly for wireless transmission of information. For example, in exemplary embodiments, the device 10 includes a Frequency Modulated (FM) receiver for receiving information such as music, Radio Data system (RDS) information, FM Traffic Message Channel (TMC) information, direct band information such as MSN Direct™ data, or the like. Alternatively, or in addition, the transmitter 36 and receiver 38 assembly may comprise a short range transmitter and transmitter such as a Bluetooth™ receiver/transmitter assembly, a cellular telephone (e.g., TDMA, CDMA, GSM, etc.) receiver/transmitter assembly, or the like.

The device 10 may also include a number of I/O ports that permit data and other information to be transferred to and from the computing device 12 and the location determining component 14. As illustrated in FIG. 1, the I/O ports may include a TransFlash card slot 40 for receiving removable TransFlash cards and a USB port 42 for coupling with a USB cable connected to another computing device such as a personal computer. Navigational software, cartographic maps and other data and information may be loaded in the device 10 via the I/O ports, the receiver 38, or the communications element 34.

The housing 24 may be handheld or otherwise portable to facilitate easy transport of the device 10. In some embodiments, the housing 24 may be configured for mounting within or on an automobile or other vehicle in a generally conventional manner. The housing 24 may be constructed from a suitable lightweight and impact-resistant material such as, for example, plastic, nylon, aluminum, or any combination thereof. The housing 24 may include one or more appropriate gaskets or seals to make it substantially waterproof or resistant. The housing 24 may take any suitable shape for size, and the particular size, weight and configuration of the housing may be changed without departing from the scope of the present invention.

The components shown in FIG. 2 and described herein need not be physically connected to one another since wireless communication among the various depicted components is permissible and intended to fall within the scope of the present invention.

In accordance with one important aspect of the present invention, a database of information related to sellers and the goods or services of the sellers is stored in the memory 16 or in an external memory which can be accessed by the electronic device 10 via the receiver 38 and/or communication element 34. The database may contain information such as the name and location of sellers; a list of the goods or services sold by the sellers (e.g., if the sellers are fuel stations, the type and grade of gasoline, diesel, ethanol, alcohol, hydrogen, electrical charging, or other fuels at the fuel stations); the prices for the goods or services (e.g. the prices for one or more types and grades of fuel provided by the fuel stations); a list of amenities provided by the sellers such as bathrooms, restaurants, telephones, etc.; payment methods accepted by the sellers; operating hours of the sellers; and any other information which consumers may want to know about the sellers and/or the goods and services sold by the sellers.

The database may be created by a data service provider and loaded in the memory 16 in a conventional manner. For example, the information may be downloaded or otherwise transferred to the device 10 from an external network or computer via a high speed Internet connection, cell phone, WiFi, etc. Because prices, and especially fuel prices, change so rapidly, the database is preferably updated at some interval such as daily by transmitting changes and updates to the device via the communication element 34 or receiver 38. Alternatively, the database may be populated and updated by the user of the device 10 and users of other devices who monitor prices in their neighborhoods and manually enter the prices into the devices. Multiple devices may then share price and seller data in a peer-to-peer fashion.

As described below, a search engine, preferably comprised of software, firmware or the like executed by the computing device 12, may search through the database for information that meets one or more search criteria entered by a user of the device. For example, the search engine may search the database for all hamburger restaurants within fifteen miles of the user's current location which have playgrounds and which sell ice cream. A user may enter any search query or term to initiate a search or the search engine may automatically search the database based on a state of the device 10 such as the current position of the device 10.

The search engine, or alternatively a separate computation engine (also preferably comprised of software, firmware or the like executed by the computing device 12), may also perform calculations related to the data from the database such as an average or median price for a specific geographic area or region (e.g., Kansas City, Kans., etc.), an average or median price for sellers within a specified distance of the device 10 (e.g., a 10 mile radius, etc.), or an average or median price for all sellers of a particular good or service within the database. The device may also determine other information such as which seller with a below average price is closest to the current position of the device, which seller within the database has the absolute lowest price, which seller within a particular geographic area has the lowest price, which seller has the highest price, which seller has the most amenities, etc.

FIG. 4 illustrates certain steps in an exemplary method 200 of using the electronic device 10 to determine and display fuel price information for fuel stations. The particular order of the steps illustrated in FIG. 4 and described herein can be altered without departing from the scope of the invention. For example, some of the illustrated steps may be reversed, combined, or even removed entirely.

The electronic device 10 continuously or periodically determines its current location as depicted in step 202. The device may determine its location with the location determining component 14 or by any other method as described above. A representation of the location may then be displayed on the display 20 or the location coordinates may simply be stored in the memory 16.

A user of the device 10 may then operate the user interface to initiate a search for fuel station information as depicted in step 204. For example, the user may enter search criteria which are used to search the database for information which satisfies the search criteria. The search criteria may request a list of all fuel stations and fuel prices for stations within a selected radius of the device; a list of all fuel stations (or those within a specified radius) having a particular grade or type of fuel; a list of all fuel stations having a desired amenity; a list of all fuel stations owned by a particular company; a list of all fuel stations which accept a particular payment method; and/or a list of all fuel stations having particular operating hours.

The computing device 12 then accesses the fuel station database and retrieves all information that satisfies the entered search query as depicted in step 206. For example, if the user requests a list of all stations of a particular company within ten miles of the user's current location that sell diesel fuel and that are open past midnight, the computing device searches the fuel station database and retrieves information for only those fuel stations that meet these search criteria.

Instead of requiring the user to initiate a search in step 204 and searching the database in step 206, the device 10 may instead automatically display the fuel prices for all fuel stations within a selected or default distance of the electronic device. For example, the user may simply operate the user interface 18 to request fuel station information, and in response, the computing device 12 may automatically search the database for all fuel stations within five miles or some other selected or default distance from the current location of the device 10.

In some embodiments, the computing device 12 may then determine a mean or median fuel price charged by the fuel stations retrieved from the database as depicted in step 208. Alternatively, the computing device may calculate a mean or median fuel price for all fuel stations within the database or only those fuel stations that are within the selected distance of the user's current location.

In step 210, the computing device may then compare the fuel prices for the fuel stations retrieved from the database to the calculated mean or median fuel price. For example, the computing device may determine whether the fuel stations have fuel prices which are above or below the mean or median fuel price calculated in step 208. The computing device may instead perform other price comparison calculations such as determining which fuel station with a fuel price below the mean or median is closest to the current location of the device.

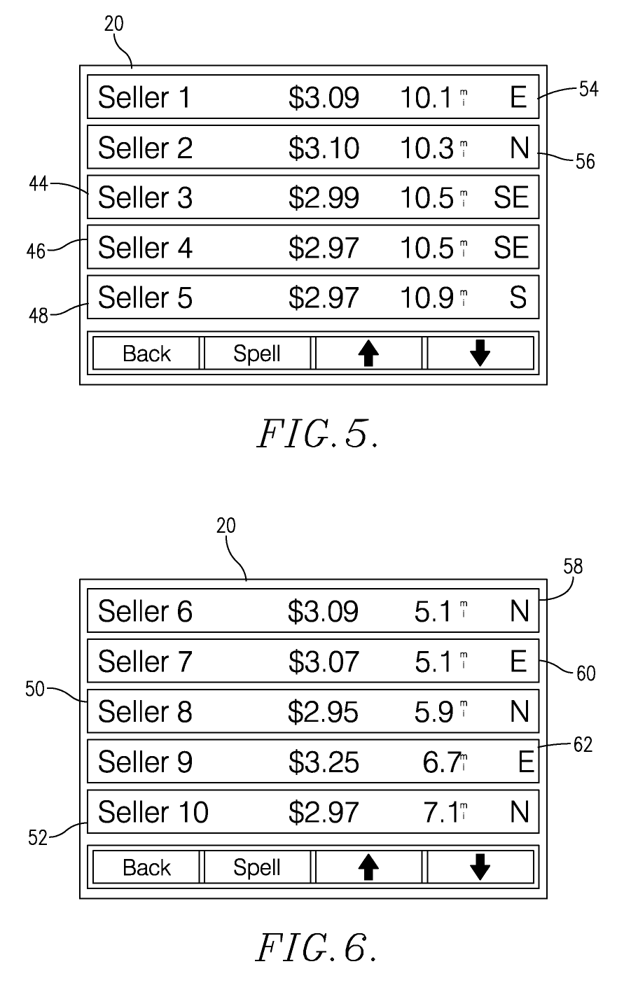

Finally, the computing device 12 may display fuel price and fuel station related information on the display 20 as depicted in step 212 and as shown in FIGS. 5 and 6. In some embodiments, the computing device 12 may display the names and locations of the fuel stations which meet the search criteria along with the fuel prices charged by the stations. The computing device may also indicate which of the fuel stations have prices below and/or above the calculated average fuel price and/or which station with a fuel price below the mean or median is closest to the device. The display of fuel prices may include at least one fuel price for each fuel station.

In one specific embodiment, the fuel prices are displayed to the user in such a way that the user can easily and quickly identify fuel prices that are below or above the mean or median fuel price. For example, the display of fuel prices may be color coded so that the text of fuel prices below or equal to the mean or median fuel price are colored green and the text of fuel prices above the mean or median fuel price are colored red. In FIGS. 5 and 6, the lines 44, 46, 48, 50 and 52 may be colored green because these fuel prices are below the mean ($3.04 per gallon) and the lines 54, 56, 58, 60, and 62 may be colored red because these fuel prices are higher than the mean. Alternatively or in addition, other display indicia may be used to indicate whether the individual fuel prices are above or below the mean or median fuel prices (e.g., arrows, highlighting, icons, or the like). Further, the least expensive and most expensive fuel prices, the closest station with prices below the mean or median price, or any other computation or result may be identified via colored text, highlighting in specific colors, an icon, or the like.

The computing device may also display fuel station icon buttons for the displayed fuel stations. A user may then select one of the fuel station icon buttons to display a route for navigating to the fuel station. A map, turn by turn directions, or other navigation assistance may then be displayed or otherwise provided for navigating to the selected fuel station. For example, if the user selects an icon or other indicator next to a displayed fuel station, the computing device may look up the address for the selected fuel station, display a representation of both the selected fuel station and the user's vehicle on a street map or other cartographic map, and then show a route between the user's current location and the selected fuel station. As the user navigates toward the selected fuel station, the device may provide turn-by-turn instructions, detour routing, or other navigation assistance.

Although the invention has been described with reference to the preferred embodiment illustrated in the attached drawing figures, it is noted that equivalents may be employed and substitutions made herein without departing from the scope of the invention as recited in the claims. For example, although the present invention is especially well-suited for providing and displaying fuel and fuel station related information, it may also be used to provide and display other price related data.

Having thus described the preferred embodiment of the invention, what is claimed as new and desired to be protected by Letters Patent includes the following:

1. An electronic device, comprising:
a display; and
a computing device for driving the display, the computing device configured to display prices charged by sellers within a selected geographic area, to compare at least some of the prices, and to provide a result of the comparison to a user of the electronic device.

2. The electronic device as set forth in claim 1, wherein the computing device is configured to determine a mean or median of the prices charged by the sellers within the selected geographic area.

3. The electronic device as set forth in claim 2, wherein the computing device is configured to indicate on the display which of the sellers within the selected geographic area have a price below the mean or median of the prices.

4. The electronic device as set forth in claim 2, wherein the computing device is configured to indicate on the display which of the sellers within the selected geographic area have a price above the mean or median of the prices.

5. The electronic device as set forth in claim 1, wherein the prices are fuel prices and the stores are fuel stations.

6. The electronic device as set forth in claim 1, wherein the selected geographic area is an area having a radius of a selected distance from a current location of the electronic device.

7. The electronic device as set forth in claim 6, further including an input device coupled with the computing device which permits a user to select the selected distance.

8. The electronic device as set forth in claim 1, wherein the selected geographic area is an area selected from the group consisting of a neighborhood, a city, a county, a town, an intersection, an area adjacent a highway exit, a metropolitan area, a state, a borough, and a country.

9. The electronic device as set forth in claim 1, further including an input device coupled with the computing device which permits a user to select one of the sellers displayed on the display and which triggers the computing device to display a route between a current location of the electronic device and the selected seller.

10. The electronic device as set forth in claim 1, further including a housing for housing the display and the computing device.

11. The electronic device as set forth in claim 1, wherein the display and the computing device are mounted in separate housings.

12. The electronic device as set forth in claim 1, further including a GPS receiver coupled with the computing device for receiving satellite signals from a plurality of GPS satellites for use in calculating a position of the electronic device as a function of the satellite signals.

13. The electronic device as set forth in claim 1, wherein the computing device is configured to display a distance between a current location of the electronic device and each of the sellers.

14. The electronic device as set forth in claim 1, wherein the computing device is configured to receive from a user search criteria and to display information which meets the search criteria.

15. The electronic device as set forth in claim 14, wherein the search criteria is selected from the group consisting of a maximum distance between a current location of the electronic device and the sellers; a type of good or service sold by the sellers; amenities offered by the sellers; names of the sellers; payment methods accepted by the sellers; and operating hours of the sellers.

16. The electronic device as set forth in claim 1, further including memory for storing seller-related information.

17. The electronic device as set forth in claim 16, wherein the seller-related information is selected from the group consisting of seller names; seller addresses; seller coordinates; seller prices; seller operating hours; seller amenities; types of goods or services of the seller; and seller payment methods.

18. The electronic device as set forth in claim 16, further including a communications apparatus for receiving the seller-related information from an external source.

19. The electronic device as set forth in claim 18, wherein the communications apparatus is selected from the group consisting of a radio transceiver; a Bluetooth™ transceiver; and a cellular transceiver.

20. A method of providing price comparison information to a consumer, the method comprising the steps:
determining a current location of an electronic device operated by the consumer;
displaying on the electronic device prices charged by sellers within a geographic area related to the current location of the electronic device; and
comparing at least some of the prices to provide the consumer with price comparison information.

21. The method as set forth in claim 20, wherein the comparing step includes determining a mean or median of the prices charged by the sellers within the geographic area.

22. The method as set forth in claim 20, wherein the prices are fuel prices and the stores are fuel stations.

23. The method as set forth in claim 20, wherein the selected geographic area is an area having a radius of a selected distance from a current location of the electronic device.

24. The method as set forth in claim 20, further including the step of receiving from a user search criteria and displaying information which meets the search criteria.

25. The method as set forth in claim 20, further including the step of navigating the consumer to one of the sellers.

26. A navigation device, comprising:
a GPS receiver for receiving satellite signals from a plurality of GPS satellites and for determining a current location of the electronic device as a function of the satellite signals;
a display; and
a computing device coupled with the GPS receiver and the display and configured to display on the display fuel prices for fuel stations within a geographic area related to the current location of the electronic device and to compare the fuel prices to determine at least one fuel station with a fuel price lower than at least one other fuel station.

27. The navigation device as set forth in claim 26, further including an input device coupled with the computing device which permits a user to select one of the fuel stations displayed on the display and which triggers the computing device to provide navigation assistance between a current location of the navigation device and the selected fuel station.

28. The navigation device as set forth in claim 26, wherein the computing device is configured to calculate a mean or median of the fuel prices charged by the fuel stations.

29. The navigation device as set forth in claim 28, wherein the computing device is configured to indicate on the display which of the fuel stations within the geographic area have a fuel price below the mean or median of the fuel prices.

30. The navigation device as set forth in claim 26, wherein the computing device is configured to display a distance between a current location of the navigation device and each of the fuel stations.

31. The navigation device as set forth in claim 26, wherein the computing device is configured to receive from a user search criteria and to display fuel prices charged by fuel stations which meet the search criteria.

32. The navigation device as set forth in claim 26, wherein the computing device is configured to determine and display a route between the current location of the electronic device and a selected fuel station.

33. A system for providing price comparison information to consumers, the system comprising:
a database of information relating to prices of goods or services and sellers which sell the goods or services; and
at least one electronic device which can access the database, display prices for sellers within a geographic area related to a current location of the electronic device, and compare the prices to provide a user of the device price comparison information.
